(19) United States
(12) Patent Application Publication
(10) Pub. No.: US 2016/0246769 A1
(43) Pub. Date: Aug. 25, 2016

(54) SYSTEM AND METHOD FOR USER COLLABORATION IN A BUSINESS INTELLIGENCE SOFTWARE TOOL

(71) Applicants: Christian Screen, Tega Cay, SC (US); Kirsten Screen, Tega Cay, SC (US)

(72) Inventors: Christian Screen, Tega Cay, SC (US); Kirsten Screen, Tega Cay, SC (US)

(21) Appl. No.: 15/048,213

(22) Filed: Feb. 19, 2016

Related U.S. Application Data
(60) Provisional application No. 62/118,111, filed on Feb. 19, 2015.

(51) Int. Cl. G06F 17/24; H04L 29/06; H04L 29/08; G06F 3/0484; G06F 17/22

(52) U.S. Cl. CPC G06F 17/243; G06F 3/0484; G06F 17/2247; G06F 17/241; H04L 67/1097; H04L 67/42; H04L 67/02

(57) ABSTRACT

A method for user collaboration in a business intelligence software tool includes executing a computing server in an operating system of a computing device including a processing unit and system memory. The computing server comprises a business intelligence tool application adapted for rendering data to a group of users for business intelligence. Using a client computer, users access the business intelligence tool application made available by the computing server. Collaborative user notes are added to a representation of data presented by the business intelligence tool application to the group of users. The user collaborative notes are saved on a data page for subsequent retrieval. The data page and user collaborative notes are shared with the group of users for collective intelligence.

### TECHNICAL FIELD AND BACKGROUND OF THE DISCLOSURE

The present disclosure relates broadly and generally to a system and method for user collaboration in a business intelligence software tool. In one exemplary embodiment, the disclosure comprises a method for storing and accessing dashboard and report comments and annotations on a Business Intelligence or Business Analytics system accessed by or otherwise integrated with an established software vendor's Analytics, Business Intelligence (BI), Visual Exploration (VE), and/or Data Discovery (DD) software products (hereafter, collectively or singularly, “Business Intelligence Tool”) to comment, mark, annotate or otherwise share, collaborate, or socialize notes, ideas, and commentary. Based on this method's primary system embodiment with a Business Intelligence Tool, portions of this method are known as “Collaborative BI” and “Embedded BI”. The system may be accessed or integrated on premise, as a cloud solution or via a Software-as-a-Service (SaaS) hosted solution. The web-based system under which the method is utilized may be programmed in a number of computer programming technologies and languages including Java, Javascript, and HTML and compiled in Java (JEE) and in parallel the Microsoft .NET framework to comply with Application Programming Interfaces (API) and Software Development Kits (SDK), from established software vendors' Business Intelligence Tools such as QlikTech's QlikView, Oracle Business Intelligence, Oracle Endeca, IBM Cognos, Information Builders WebFocus, and Tibco Spotfire.

In one exemplary application, the present invention relates broadly and generally to the computer systems and methods for interfacing with data such as database information; and relates more specifically to a computer system and method for annotating, commenting, reading, writing and otherwise collaborating within a Business Intelligence Tool or Business Analytics system.

Current Enterprise or Departmental Business Intelligence (BI) Tool systems provide an organization's applications and users, such as consumers of analytics or analytical information and data (hereinafter referred to generically as “users”) the ability to analyze data using dashboards, reports, and other navigational and visualization data exploration techniques. Data Discovery (DD) tools are similar in nature to BI tools in that they allow an organization to analyze a various set of heterogeneous and homogeneous data with less coupled or modeled relationships between the data. Data Discovery tools are often provided to a subset of users, often only power analysts and data scientists within the organization, to analyze data in a less structured manner. Sharing analytical information, data discoveries and collaborating on discoveries or analyses from the Business Intelligence Tool systems, especially when important decisions need be made is left as a manual, usually via email, or non-existent process. As such there is no contextual reference to discoveries, no accountability to those tasked with analytical investigation, and no fluent means to collaborate on decisions based on information exposed through the Business Intelligence Tool or Data Discovery system.

Over the last several years the advance of Social Networking organizations such as Linkedln, Facebook, and others social networks have shown that collaborating with a group of users having a common relationship at some level provides the outlet and means to make better decisions using collective intelligence, that is the combined input and experiences of a group working towards a common purpose. Social Networks have been initially targeted at consumers and individuals and not at organizations. In the last few years Enterprise organizations have proven that the ability to collaborate and share ideas in the organization, particularly in larger organizations, provides the means for stronger decisions to be made. It also reduces individual silos of knowledge and increases accountability. Existing Business-to-Business corporations have attempted to capitalize on the success of the consumer Social Networks by developing new social networks and positioning their use for Enterprise business organizations. These Enterprise Social Networks (ESN) such as Salesforce Chatter, Microsoft Yammer, Oracle Social Network, SAP Jam, have been introduced to bring the collective intelligence and “group think” concepts to Enterprise organizations.

The Business Intelligence Tool systems from established software vendors such as Oracle, IBM, Information Builders, Tibco, and QlikTech allow end-users of the software to view an organization's data and analyze the data through dashboards and reports. However the ability to comment or annotate the dashboards and reports is typically limited or non-existent. In addition, larger organizations integrating Enterprise Social Networks as a central means to communicating between internal departments and external business relationships, such as third party vendors, for the purpose of collective intelligence or “group think”, have no means to directly communicate from within the aforementioned Business Intelligence Tool systems for collaboration.

It is with respect to these and other considerations that the present invention has been made.

### SUMMARY OF EXEMPLARY EMBODIMENTS

Various exemplary embodiments of the present invention are described below. Use of the term “exemplary” means illustrative or by way of example only, and any reference herein to “the invention” is not intended to restrict or limit the invention to exact features or steps of any one or more of the exemplary embodiments disclosed in the present specification. References to “exemplary embodiment,” “one embodiment,” “an embodiment,” “various embodiments,” and the like, may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

It is also noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Aspects are directed to allow users to interact with a web-based graphical user interface (GUI) embedded in an Business Intelligence Tool system enabling a user to read or write a comment to be associated with a dashboard, or dashboard page or tab, and the views, reports, tables, graphs, or charts, from which it is comprised or annotate a cell of a table, grid, pivot-table or other representation of data on a dashboard, dashboard page or tab, or report. Metadata, which is data about that data, associated with the comments or annotations are stored in a database or file system for persistent storage. The GUI is comprised of several input forms, navigation panes and prompts and can be customized per the administration GUI of the system.

According to one exemplary embodiment, the present disclosure comprises a method for user collaboration in a business intelligence software tool. The method includes executing a computing server in an operating system of a computing device including a processing unit and system memory. The computing server comprises a Business Intelligence Tool application adapted for rendering (e.g., retrieving, analyzing, transforming, or reporting) data to a group of users for business intelligence. Using a client computer, users access the Business Intelligence Tool application made available by the computing server. The client computer has an input device and an output device. Collaborative user notes are added to a representation of data presented by the Business Intelligence Tool application to the group of users. The collaborative user notes are added using the client computer to access data rendered by the Business Intelligence Tool application and displayed on a data page through the output device. The data rendered by the Business Intelligence Tool application may comprise, for example, a dashboard, or dashboard page or tab, and the views, reports, tables, graphs, or charts, from which it is comprised; or a cell of a table, grid, pivot-table or other representation of data on a dashboard, dashboard page or tab, or report. Using the input device of the client computer, user collaborative notes are entered in a designated field on the data page. The user collaborative notes are saved on the data page for subsequent retrieval. The data page and user collaborative notes are shared with the group of users for collective intelligence.

As used herein, the term “user collaborative notes” refers broadly to any marking, color, symbol, notation, word, phrase, comment, annotation, graphic, icon, emoji, digital image, sound, video, HTML tag, web link, or the like entered in the designated field of the data page. The term “designated field” refers broadly herein to any space allocated for entering collaborative notes.

According to another exemplary embodiment, the method comprises providing a designated collaboration pane on the data page displayed by the output device for entering contextual collaboration information.

According to another exemplary embodiment, the method comprises providing an electronic form for entering collaborative user notes on the data rendered by the Business Intelligence Tool application and displayed on the data page through the output device.

According to another exemplary embodiment, the method comprises providing a selector to identify a specific element of data rendered by the Business Intelligence Tool application and displayed on the data page through the output device.

According to another exemplary embodiment, the method comprises providing a selector to categorize a collaborative user note displayed on the data page through the output device.

According to another exemplary embodiment, the method comprises providing a search form to filter collaborative user notes displayed on the data page through the output device.

According to another exemplary embodiment, the method comprises providing an opinion (e.g., “like” or “dislike”, or vote, or rating) option for other users in the group to opine on the collaborative user notes displayed on the data page through the output device.

According to another exemplary embodiment, the method comprises restricting access to the user collaboration notes to authorized users of the group.

According to another exemplary embodiment, the method comprises bookmarking the data page associated with the user collaborative notes.

According to another exemplary embodiment, the method comprises assigning a user collaborative note to a selected user of the group.

According to another exemplary embodiment, the method comprises selecting a collaboration storage location for writing user collaborative notes pertaining to the data rendered by the Business Intelligence Tool application.

According to another exemplary embodiment, the collaboration storage location comprises an enterprise social network.

According to another exemplary embodiment, the collaboration storage location comprises a metadata repository database.

According to another exemplary embodiment, the collaboration storage location comprises a physical file system selected from a group consisting of a flat file, XML formatted file, and binary file.

According to another exemplary embodiment, the method comprises providing a collaboration graphical user interface integrated with the Business Intelligence Tool application.

In another exemplary embodiment, the disclosure comprises a computer-implemented system for user collaboration in a business intelligence software tool. The system utilizes a computing server executed in an operating system of a computing device including a processing unit and system memory. The computing server comprising a Business Intelligence Tool application adapted for rendering data to a group of users for business intelligence. A client computer is adapted for accessing the Business Intelligence Tool application made available by the computing server, and comprising an input device and an output device. The computing device comprises computer-executable instructions stored in the system memory that when executed by the processing logic cause the processing logic to enable the present exemplary method for adding collaborative user notes to a representation of data presented by the Business Intelligence Tool application to the group of users.

In yet another exemplary embodiment, the disclosure comprises a computer program product including program instructions tangibly stored on a computer-readable medium and operable to cause a computing device to perform the present exemplary method for adding collaborative user notes to a representation of data presented by a Business Intelligence Tool application to a group of users.

In still another exemplary embodiment, the present disclosure comprises a method to be executed at least in part in a computing device for reading and writing comments and annotations against a Business Intelligence Tool based on the context of dashboards and reports. The method includes one or more of providing a form for entering comments or annotations on the currently selected dashboard or report; providing a selector to identify a specific grid, table, or pivot table cell for annotation; providing a collaboration pane providing full contextual collaboration information; providing a selector to categorize a comment or annotation; providing a search form to filter commentary based on the currently selected dashboard or report; providing a “like” or vote option for other users to recognize or otherwise escalate or promote the insightfulness ranking of a comment or annotation; providing a reply system for creating a comment thread or conversation between one or more users; proving a system for printing comments and annotations generically or in context to the users current point of view; providing an input column within an existing or new tabular report object or view object for the purpose of annotating or commenting; and proving a system which captures the context of the comment or annotation from which it was originally authored.

According to another exemplary embodiment, the method further comprises a security privilege system for granting access to users or groups to use the system.

According to another exemplary embodiment, the method further comprises an ability to bookmark the current context of a dashboard or report allowing a comment to retrieve the specific context under which the comment was written.

According to another exemplary embodiment, the method further comprises an ability to assign a comment to one or more users or groups.

According to another exemplary embodiment, the method further comprises an ability to input images or video as part of the comment or annotation.

According to another exemplary embodiment, the method further comprises an ability to input HTML tags or logic as part of the comment or annotation.

According to another exemplary embodiment, the method further comprises an ability to reply to comments or annotations.

According to another exemplary embodiment, the method further comprises an ability to delete to comments or annotations.

According to another exemplary embodiment, the method further comprises a selection option based on the privilege system to choose a collaboration storage location for writing comments pertaining to the selected dashboard or report.

According to another exemplary embodiment, the collaboration storage location is an Enterprise Social Network or the collaboration metadata repository database.

According to another exemplary embodiment, the collaboration storage location is a physical file system store such as a flat file, XML formatted file, or binary file.

In yet another exemplary embodiment, the disclosure comprises a system for generating dashboard comments and highlighting dashboard report and view cells of pivot tables, tables, and grids. The system comprises a collaboration application configured to manage comments and annotation metadata and provide a seamless presentation base on currently selected dashboards or reports. The meta data of the system is stored in a data source. A GUI presents interactive forms and metadata regarding comments, annotations, and Business Intelligence Tool system information.

According to another exemplary embodiment, the collaboration GUI is integrated with a Business Intelligence Tool system.

According to another exemplary embodiment, the highlighting, background, or image/icon of the tabular view cell containing an annotation comment is dynamically managed by an administrator or by user preference.

According to another exemplary embodiment, the system comprises the ability to secure a comment and select the permissions or privileges on interacting with a comment based on selected user, group, or user/group associated with an application role.

These and other features and advantages will be apparent from reading the following detailed description and a reviewing the associated drawings. It is to be understood that both the foregoing general description and the following detailed description are explanatory only and are not restrictive of aspects as claimed.

### BRIEF DESCRIPTION OF THE DRAWINGS

FIG. 1 is a block diagram of an exemplary Business Intelligence Tool computing operating environment architecture;

FIG. 2 illustrates a system where example embodiments may be implemented;

FIG. 3 illustrates an example collaborative BI architecture according to embodiments;

FIG. 4 illustrates an example collaboration pane interface within a Business Intelligence Tool;

FIG. 5 illustrates an example collaboration input form prompt interface within a Business Intelligence Tool;

FIG. 6 illustrates an example graphical user interface for selecting, reading and writing metadata according to the embodiments from within a Business Intelligence Tool system;

FIG. 7 illustrates an example graphical user interface form for comment and metadata input, prompt selections and, general display and input functionality according to the embodiments;

FIG. 8 illustrates an example graphical user interface of integrated inline cell commenting for comment and metadata input, comprising one or more fields which may allow read and/or write accessibility, and general display, option selections, and input functionality according to the embodiments; and

FIG. 9 illustrates an example graphical user interface of integrated inline cell commenting for comment and metadata input, comprising multiple comment fields which may allow read and/or write accessibility of metadata, option selections, and input functionality according to the embodiments; and

FIG. 10 demonstrates an exemplary workflow for user collaboration in a Business Intelligence Tool according to one implementation of the present disclosure.

### DESCRIPTION OF EXEMPLARY EMBODIMENTS AND BEST MODE

The present invention is described more fully hereinafter with reference to the accompanying drawings, in which one or more exemplary embodiments of the invention are shown. Like numbers used herein refer to like elements throughout. This invention may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limiting as to the scope of the invention, which is to be given the full breadth of the appended claims and any and all equivalents thereof. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at least one of the items, but does not exclude a plurality of items of the list.

For exemplary methods or processes of the invention, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Additionally, any references to advantages, benefits, unexpected results, or operability of the present invention are not intended as an affirmation that the invention has been previously reduced to practice or that any testing has been performed. Likewise, unless stated otherwise, use of verbs in the past tense (present perfect or preterit) is not intended to indicate or imply that the invention has been previously reduced to practice or that any testing has been performed.

As briefly described above, a user may read or write one or more comments or annotations per a specific dashboard, dashboard page, or dashboard report or view using the system which is deployed either on-premise, that is local to the Business Intelligence Tool's system architecture or deployed off-premise, that is remotely hosted (such as in the “cloud”). In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

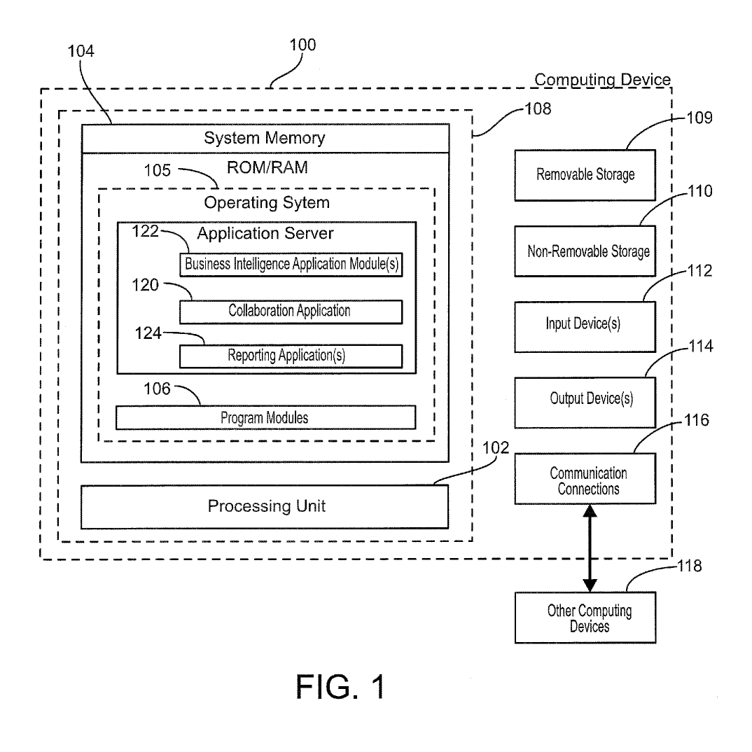

Referring now to the drawings, aspects and an exemplary Business Intelligence Tool's system architecture and computing operating environment will be described. FIG. 1 and the following discussion are intended to provide a brief, general description of a suitable computing environment in which the invention may be implemented. While the embodiments will be described in the general context of program modules that execute in conjunction with an application program that runs on an operating system on a personal electronic consumption device such as an operating system on a personal computer, server, or a mobile device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory and physical storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

With reference to FIG. 1, one exemplary system for implementing the embodiments includes a computing device, such as a computing device 100. In a basic configuration, the computing device 100 typically includes at least one processing unit 102 and system memory 104. Depending on the exact configuration and type of computing device, the system memory 104 may be volatile (such as RAM), non-volatile (such as ROM, flash memory, etc.) or some combination of the two. System memory 104 typically includes an operating system 105 suitable for controlling the operation of a networked personal computer or server, such as the LINUX, UNIX, or WINDOWS operating systems. The system memory 104 may also include one or more software applications such as program modules 106, collaboration application 120, Business Intelligence Tool application 122, and reporting application(s) 124. Collaboration application 120 manages comments and annotations evaluation methods, communicates with Enterprise Social Networks, and provides collaboration data to dashboards and reports in the Business Intelligence Tool application 122. In some embodiments, the collaboration application 120 may itself generate reports based on collaboration metadata or the Business Intelligence Tool application metadata.

The Collaboration application 120 integrates into the Business Intelligence Tool application 122 by way of API and SDK logic and other templates which embed GUI presentation forms and dynamic HTML into the Business Intelligence Tool application 122 dashboards, reports, and other presentation pages as well as additional Reporting Applications 124. The Collaboration application 120 may be an integrated part of the Business Intelligence Tool application 122 or a separate application. Collaboration application 120, Business Intelligence Tool application 122, and reporting application(s) 124 may communicate between themselves and with other applications running on computing device 100 or on other devices. Furthermore, any one of Collaboration application 120, Business Intelligence Tool application 122, and reporting application(s) 124 may be executed in an operating system other than operating system 105. This basic configuration is illustrated in FIG. 1 by those components with dashed line 108.

The computing device 100 may have additional features or functionality. For example, the computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital Versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. These devices are well known in the art and need not be discussed at length here.

The computing device 100 may also contain communication connections 116 that allow the device to communicate with other computing devices 118, such as over a network in a distributed computing environment, for example, an intranet or the Internet. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. Additionally, other computing devices 118 may represent Software-as-a-Service hosted solutions known also as “cloud computing” which may be used as a storage mechanism for reading and writing metadata or data for any portion of the system contained within the basic configuration of the computing device 100.

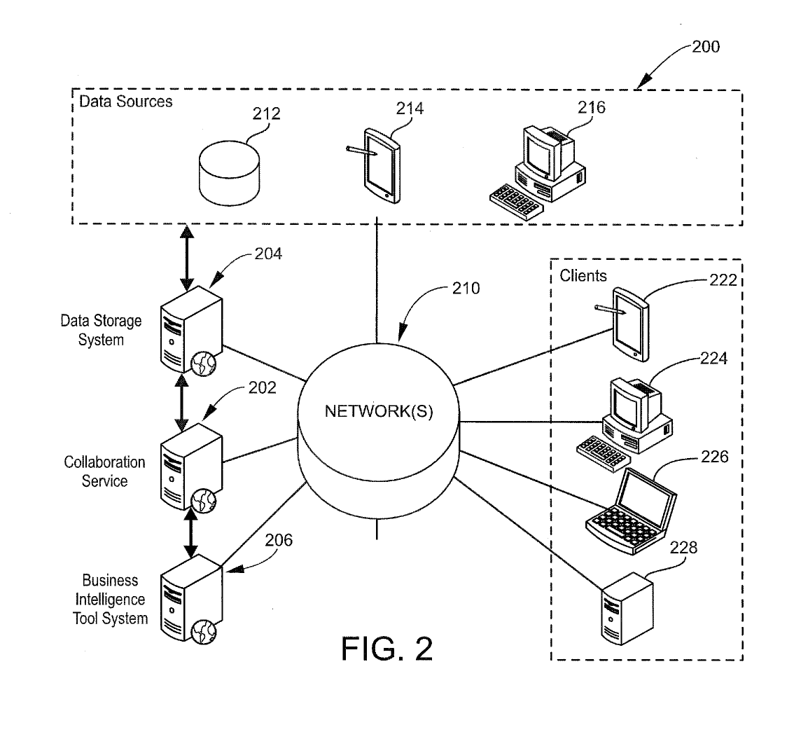

Referring to FIG. 2, a system where example embodiments may be implemented is illustrated. System 200 may comprise any topology of servers, clients, Internet service providers, and communication media. Also, system 200 may have a static or dynamic topology. The term “client” may refer to a client software application or a client device employed by a user to perform business logic operations or otherwise consume information from network connected systems. Collaboration service 202, Data Storage System 204, and Business Intelligence Tool System 206 may also be one or more programs or a server machine executing programs associated with the server tasks. Both clients and application server(s) may be embodied as a single device (or program) or a number of devices (or programs). Similarly, metadata and data sources may include one or more data stores, file structures, input devices, and the like.

A business logic software application may be run centrally on Collaboration Service 202 or in a distributed manner over several servers and/or client devices. This includes but is not limited to a clustered environment over one or more physical servers. Collaboration Service 202 may include implementation of a number of systems outputs relating the Business Intelligence Tool system such as aggregated measures, embedded charting and graphing functionality, exception reporting, usage reporting, comment and annotation management, and administrative functionality. A number of organization-specific applications including, but not limited to, analytical reporting, financial reporting, analysis, marketing analysis, customer service, enterprise resource planning, spreadsheets, flat files, and planning applications may also be configured, deployed, and shared in system 200, 202, 204, or 206. In addition, the business logic application may also be run in one or more client devices and exchange information over network(s) 210.

Data sources 212, 214, 216 are examples of a number of data sources that may provide input to the Collaboration Service application 202 through Data Storage System 204 or directly through Network(s) 210. Additional data sources may include Relational Database Management Systems (RDBMS), SQL databases, No-SQL database, in-memory databases, flat files, multi-dimensional data sources such as data cubes, non-multi-dimensional data sources and the like. Data Storage System 204 may manage the data sources, persist metadata, optimize queries, and the like.

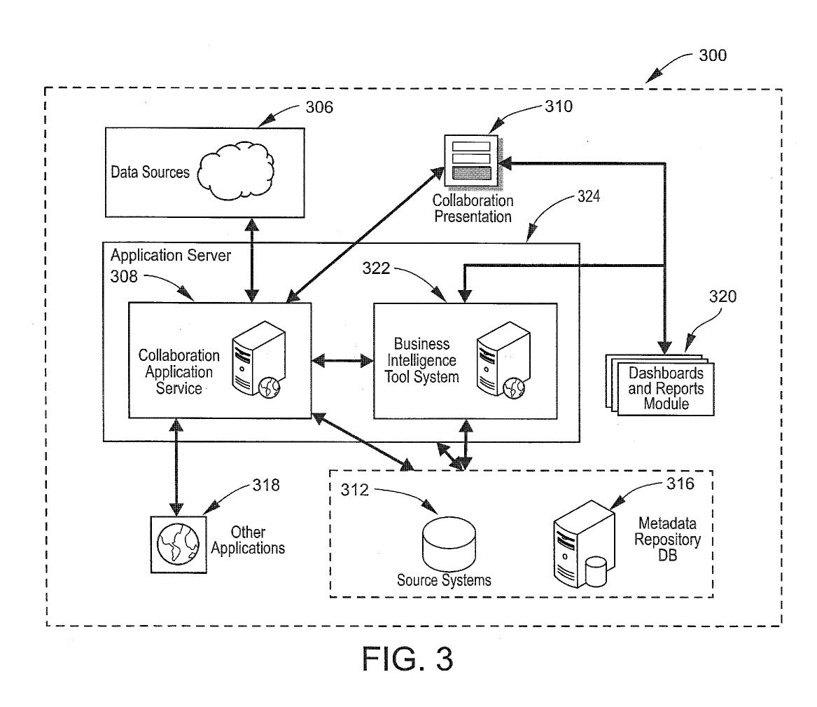

Collaboration Service 202 may be a logical or physical representation of technology in FIG. 2. Collaboration Service 202 may be integrated as part of the Business Intelligence Tool System 206 code, as a software plug-in that interfaces with the Business Intelligence Tool System 206, its application server, or its configuration files. Collaboration Service 202 may integrate with the Business Intelligence Tool System 206 through the Network(s) 210, through a firewall if necessary, to another physical or logical server through an intranet or the Internet. Users may interact with Collaboration Service 202 from client devices 222, 224, and 226 over the network(s) 210 in coordination with Business Intelligence Tool System 206 or independently. In one embodiment, additional applications that consume collaboration-based data and metadata may reside on the on collaboration service 202 or client devices 222, 224, 226. Examples of such applications and their relation to the collaboration application are provided below in conjunction with FIG. 3.

Business Intelligence Tool System 206 may include dashboard and reporting applications such as distributed and self-service reporting, charting applications, alerting applications, analysis applications, and the like. These applications may receive, render or otherwise integrate collaborative data or metadata from the Collaboration Service 202 and provide collaboration or annotation functionality directly or through the Business Intelligence Tool System 206 providing the ability to collaborate or annotate any area of GUI output rendered by the Business Intelligence Tool System 206.

Network(s) 210 may include a secure network such as an enterprise network, or an unsecure network such as a wireless open network, internally or externally within one or more organizations. Network(s) 210 provide communication between the nodes described above. By way of example, and not limitation, Network(s) 210 may include wired media such as a wired network or direct-wired connection, and wireless media such as acoustic, RF, infrared, Bluetooth, Wi-Fi and other wireless media.

This system along with other configurations of computing devices, applications, data sources, data distribution and analysis systems may be employed to implement a business logic application for collaboration and subordinate reporting.

Now referring to FIG. 3, example collaboration architecture 300 is illustrated. Collaboration architecture 300 may comprise any topology of processing systems, storage systems, source systems, and configuration systems. Collaboration architecture 300 may also have a static or dynamic topology.

The present invention is a method of commenting and annotating dashboards, dashboard pages, reports, graphs, charts, tables, pivot tables, and views rendered by the Business Intelligence Tool. Comments and annotations vary based on context of data, time, and other factors some of which are subjective to the experience or point-of-view of the user creating or reading the comment. In the exemplary collaboration architecture 300, a core of the system is the Collaboration Application Service 308. Collaboration Application Service 308 may be an software application or program that is developed or arranged to accept and respond to requests for reading and writing comments and annotations. Collaboration Application Service 308 may be loaded or deployed to an application server that co-exists with the Business Intelligence Tool system or separately, executed over a distributed network, local network, or single workstation then having its output consumed via a client device, Other Applications 318, and the like.

In addition to performing collaboration functions, the Collaboration Application Service may also provide metadata, graphs, reports, and other charting information to Other Applications 318 by providing the means to embed the Business Intelligence Tool metadata in Other Applications 318 on the Network(s) 210. The Collaboration Application Service may also provide such as capabilities aggregating user usage, recording response and sentiment to comments and annotations, and capturing other details related to the collaboration functionality as it relates to the integration with the Business Intelligence Tool System 322.

Metadata Repository DB 316, the database repository or file system for persisting collaboration data and metadata, is arranged to store metadata and in some cases data related to the Collaboration Application Service 308 and is retrieved directly or via the Application Server 324 database driver or file system read connections.

Collaboration Presentation 310 is a web-based GUI of the Collaboration Application Service 308 or the Business Intelligence Tool System 322, and the like. Collaboration Presentation 310 is employed as the Graphical User Interface (GUI) to read, write, or otherwise send request to and receive responses from the Collaboration Application Service 308. Collaboration Presentation 310 may include an administrative management GUI or web service(s), user form(s) for user inputs, web page(s) or web service(s), or a collaboration panel that displays or otherwise rendered in the Business Intelligence Tool System 322 Dashboards and Reports Module 320, and the like.

Data Sources 306, which are considered data storage systems or services, may be another medium for providing raw data or metadata to the Collaboration Application Service 308. Data Sources 306 may be comprised of one or more in-memory databases, relational databases, file system files, other Open Database Connectivity (ODBC)-accessible data source systems (e.g. Microsoft Excel, text files, etc.), JSON data, XML data, or other remotely or locally hosted system data or metadata, subscribed to or otherwise offered and/or hosted by a third-party vendor (e.g. Salesforce Chatter, Microsoft Yammer, Citrix Systems Podio, Oracle Social Network, etc.).

Dashboards and Reports Module 320 is the GUI presentation component of the Business Intelligence Tool System 322 in which the present invention's collaboration services and functionality is integrated.

Other Applications 318 may include any application that receives data or metadata associated with the Business Intelligence Tool System 322 or Collaboration Application Service 308. Other Applications 318 may be determined based on availability as well as the ability to integrate a code snippet, typically but not exclusively in the form of JavaScript, which communicates with the Collaboration Application Service 308 to reference functionality such as embedded charts, reports, collaboration comments, annotations, or other metadata stored or maintained by the Collaboration Application Service 308. Other Applications 318 may include a graphical representation application, a database application, a data analysis application, a Collaboration Portal (e.g.: Microsoft SharePoint) or Content Management System (CMS) portal, a communications application, an alerting application, a word processing application, or a spreadsheet application.

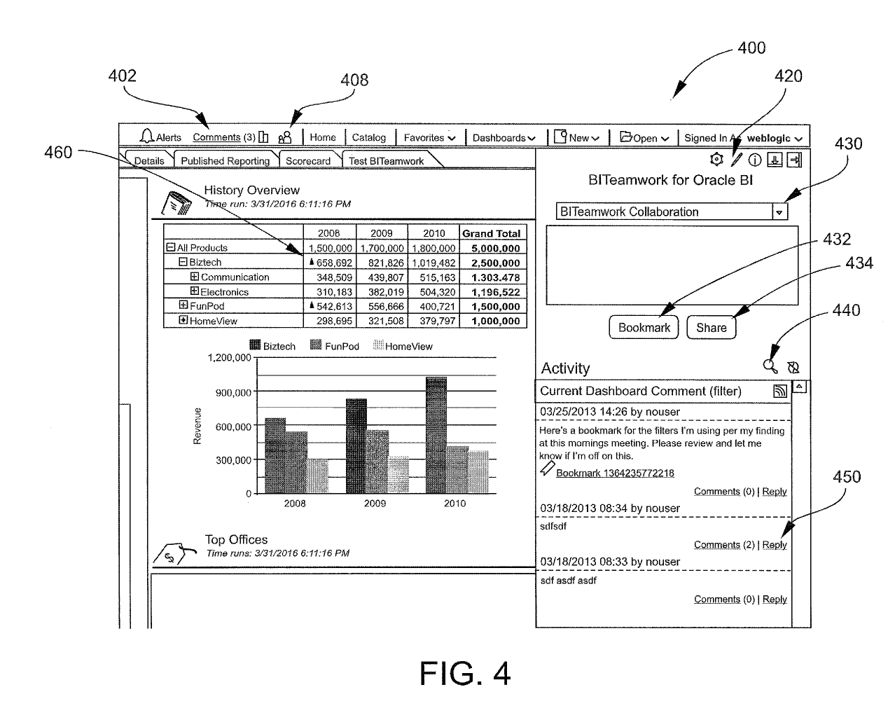

Now referring to FIG. 4, an exemplary analytics or Business Intelligence Tool's web based or client accessible portal or interface wherein the Collaborative Application provides Collaboration Integration Options 430 to interact with third party Enterprise Software as a Service application, Save, Post or Add a Collaborative Note 432 and 434, Search for Collaborative Notes 440, Reply to Respond to Collaborative Notes 450, Rendered tabular report cell annotation 460, or view the quantity of Collaborative Notes 402 on the an exemplary analytics or Business Intelligence Tool's interface.

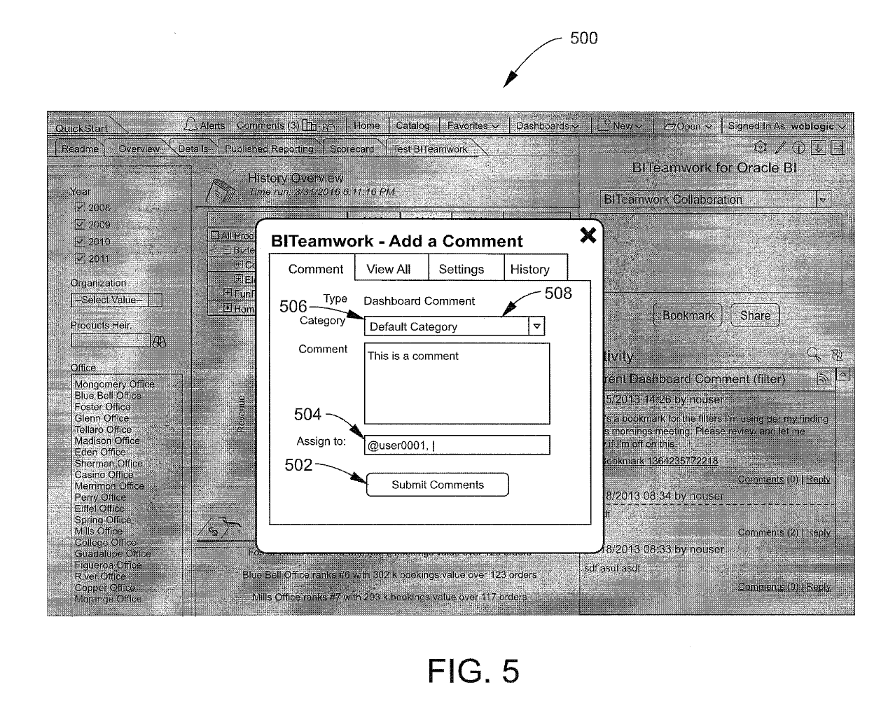

Now referring to FIG. 5. A system where the example embodiments may provide a non-static or static input form within an exemplary analytics or Business Intelligence Tool's web based or client accessible portal or interface wherein the Collaborative Application provides ability to enter a Collaborative Note 506, determine taxonomy for the Collaborative Note 508, Notify or Assign to Collaborative Note to a user or group by email, user identifier, or other identifying means 504, or the ability to Save, Share or Submit the Collaborative Note.

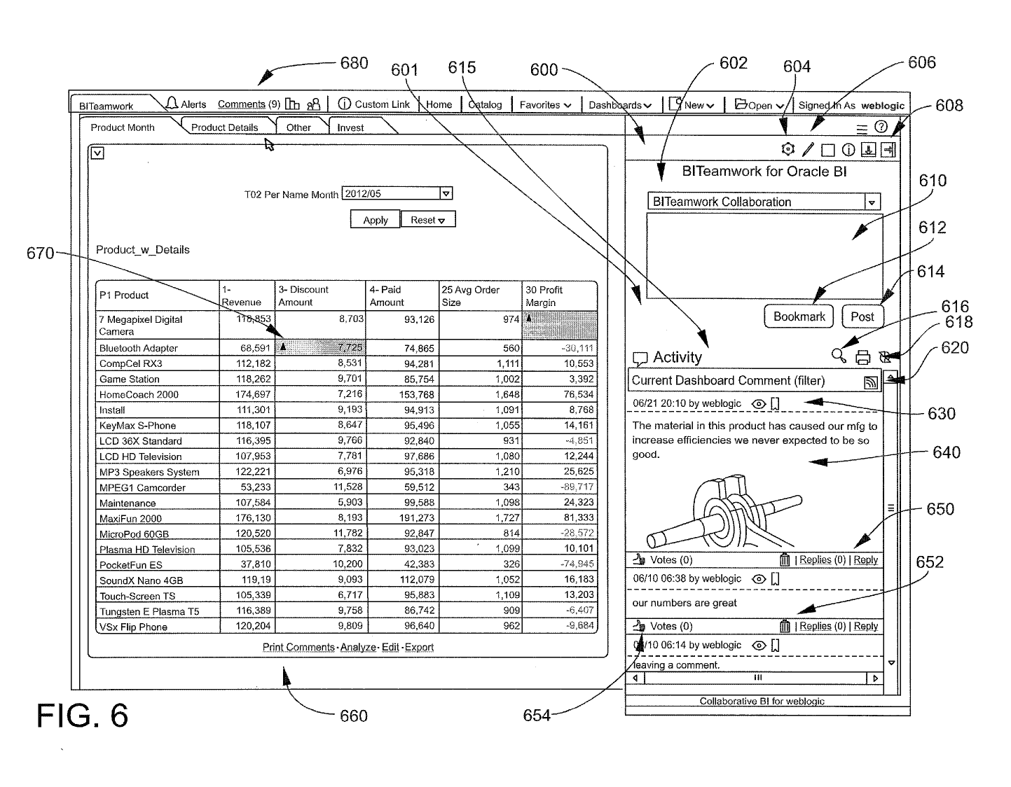

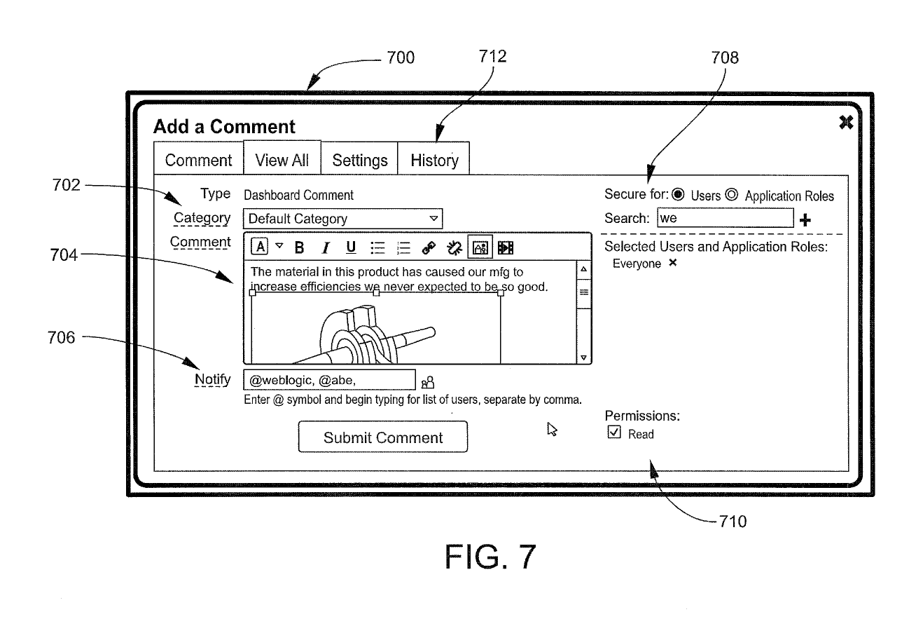

Now referring to FIG. 6, a system where example embodiments may be displayed and otherwise utilized by users is illustrated. Collaboration display pane 600 is the general containment area for rendering one or more functions of the system for the user to interface with in order to consume or input the metadata associated with comments and annotations. Users may input a comment into the comment form field 610 or open the editor 700 by clicking an advanced editor button 601 which opens an input form with additional comment formatting options as illustrated in FIG. 7. Comments storedi the system or other third-party metadata such as comments or other metadata from enterprise social networks such as Salesforce Chatter, Microsoft Yammer, Citrix Podio, and Oracle Social Network, for example, can be viewed in the activity area 615 of the collaboration display pane by using the activity selector 602. A user settings toggle 604, which allows for the modification of how a user's default interactions with the system are controlled. A visual augmentation option 606 to overlay the existing content displayed to the user for markup or other annotation is accessible via mouse click on visual augmentation sketch 606 icon button. Collaboration pane may collapse or be minimized to reduce the display of the majority of features available in the system visible on the web page via mouse click on minimize, maximize, or dock 608 icon button. One or more options for posting, saving, or otherwise storing a comment within the collaboration display pane 600. An option to store the comment entry input into the comment field 610 with a specific contextual reference to the Business Intelligence Tool system's dashboard, report, or other graphical view for storage to disk or other third-party vendor system with or without specific contextual reference to the Business Intelligence Tool system's dashboard, report, or other graphical view may be achieved by clicking the buttons 612, 614 associated with saving the metadata created by the user.

Interface has options to search 616 through comment metadata, print 618 comments associated with the immediate or referenced context. Additionally comments and associated metadata may be viewed by Rich Site Summary (RSS) feed 620. Comments stored using the system or retrieved from another third-party enterprise social network are visible in the activity area 615 and have options 630 related to controlling each comment individually to manage the comment by editing, viewing, distributing by Uniform Resource Locator (URL) link or bookmark link. Each comment or annotation is visible 640 with any graphics and/or text as authored and stored and retrieved in context, via searching 616, or by default filter and/or user preference filter, in the activity area 615 for which the comment is displayed using Hypertext Markup Language (HTML) and HTML5 technology. In addition to the display of each comment 640 and its metadata option 630 additional management and control options 650 are available to increase the metadata associated with the comment. These control options 650 provide additional users of the system to reply to the comment in order to create a response which creates a thread or a conversation based on the original comment and/or its replies. Additionally the control options 650 provide interactive options such as voting and/or liking 654 a comment to increase the comments approval by the other users having access to the system.

Comments may be printed in context to the filters and predicates applied to the current dashboard or report for which the comment was originally authored. One or more areas 616,660 or options are available for printing the comments or annotations so that they can be displayed or exported in one or more formats for export such as a portable document format (PDF) or immediate readability within the web browser.

Within a report displayed on a dashboard or otherwise displayed to the user of the BI System, cell annotations or comments are displayed within the tabular view so that an indicator 670 visibly shows that a comment or annotation exists for a cell within the tabular view. The cell indicator 670 has several management configuration options which determine the background color, icon, or other related text properties which produce the cell indicator's visibility to an end-user in order to convey that a comment or annotation exists for the indicated cell on the tabular view.

Other controls or toolbars 680 related to the system have the ability to show within the BI System to provide multiple points of access for authoring comments, viewing comments, or providing an indication to statistical information regarding the quantification of commentary and/or annotation per the selected dashboard or report.

Now referring to FIG. 7, a system where example embodiments may be input, authored, stored and otherwise utilized by users is illustrated. As users leverage one of the several available options available per the system to initiate the creation of a new comment or annotation a form field interface 700 is made available. Several options within the interface allow a user to author dynamic or static content. The system's interface allow for attributes such as taxonomy, tags, or category 702 to be related to the comment or annotation by selecting a pre-defined or dynamically defined category from a list of options or by having the user provide free form input into the field. A comment or annotation input field 704 is available to allow a user to author the content. The input field 704 can be static or dynamic and can allow for the authoring of text with Hypertext Markup Language (HTML) formatting and tags. The input field 704 can also allow for the input of images and video which can be dynamically or manually resized to provide graphical content. An additional component of the system provides the author of the comment content with the ability to notify other users of the BI System by inputting the user which should be notified upon the submission of the comment or annotation for storage by using a notification input field 706. Notification of other users within the BI System is managed by the Collaboration Application Service which integrates with the Application Server 324 and distributes a message via email or the BI System's native notification, to the user, group, or application role input into the notification input field 706. During or after the authoring of the comment or annotation the content of the comment may be secured or otherwise restricted to allow certain users, groups, or users/groups within specified application roles to view or act upon the comment. This ability to permit activity upon the comment or annotation is modified by using the security option 708 controls. As a user is creating a comment or annotation they may access previously authored comments or annotations by accessing the history of comments authored by their profile by selecting a historical option in the form field interface 700 prompt.

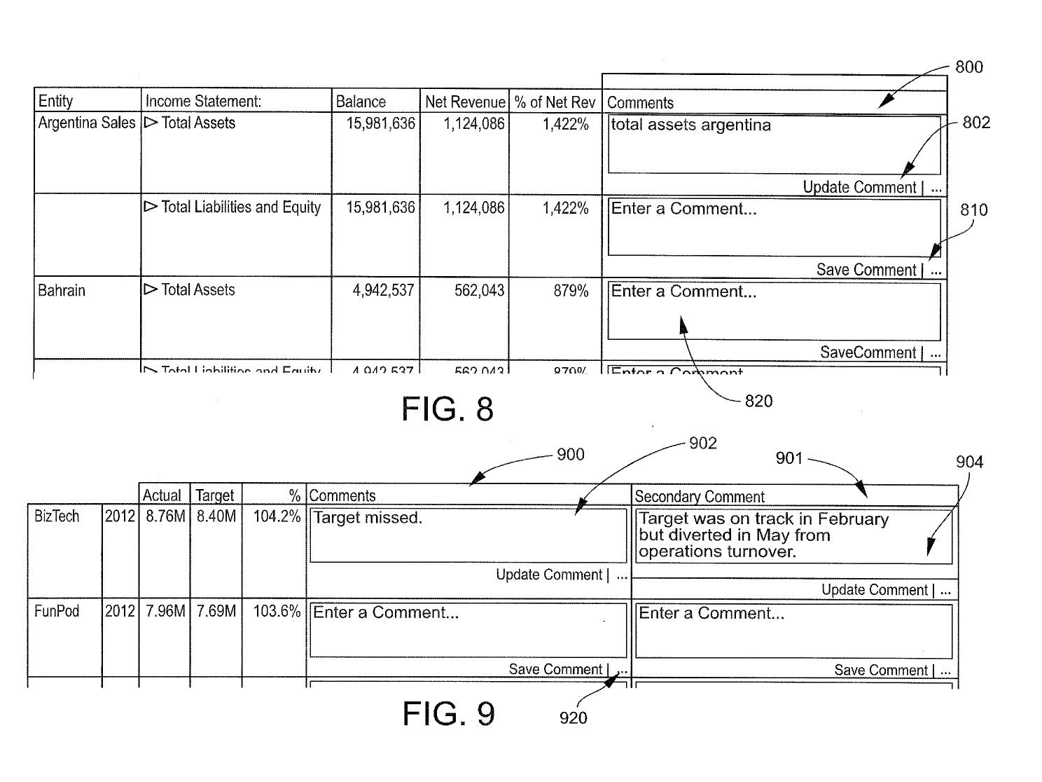

Now referring to FIG. 8 and FIG. 9, a system where the example embodiments may be input, authored, read, stored and otherwise consumed or utilized by users is illustrated. Per individual reporting object or otherwise as a global configuration the embodiment may establish one or more columns 800 for entering comments or annotations, at any level of granularity and contextual referenced, intersecting with one or more corresponding rows of data in a new or existing pivot table, table, or other tabular structure containing data or metadata. Textual or other Information may be input or entered into the embodiment manually or via automation and saved or stored for immediate access and later retrieval. Additional options 810 access may provide for security, attribute definitions, notifications, and other ancillary reference to the embodiment. The embodiment comment field may be adorned with a textual placeholder, similar visual reference or other description 820 prior to a comment being entered into the field. Columns shown in the embodiment, multiple columns 900, 901 or otherwise 800, may have header titles or not, and may be configurable or not through use of configuration input specific to each report or established globally through any form including an Application Programming Interface (API).

FIG. 10 demonstrates an exemplary workflow for user collaboration in a business intelligence software tool, and more specifically for cell comment or annotation according to the present disclosure.

For the purposes of describing and defining the present invention it is noted that the use of relative terms, such as “substantially”, “generally”, “approximately”, and the like, are utilized herein to represent an inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The above specification, examples and data provide a complete description of the integration, topology, manufacture and use of the composition of the embodiments. Although the subject matter has been described in language specific to structural features and/or methodical acts, it is to be understood that the subject matter defined in the appended claims is not necessarily limited to the specific features or acts described above. Rather, the specific features and acts described above are disclosed as example forms of implementing the claims and embodiments.

Exemplary embodiments of the present invention are described above. No element, act, or instruction used in this description should be construed as important, necessary, critical, or essential to the invention unless explicitly described as such. Although only a few of the exemplary embodiments have been described in detail herein, those skilled in the art will readily appreciate that many modifications are possible in these exemplary embodiments without materially departing from the novel teachings and advantages of this invention. Accordingly, all such modifications are intended to be included within the scope of this invention as defined in the appended claims.

In the claims, any means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Unless the exact language “means for” (performing a particular function or step) is recited in the claims, a construction under §112, 6th paragraph is not intended. Additionally, it is not intended that the scope of patent protection afforded the present invention be defined by reading into any claim a limitation found herein that does not explicitly appear in the claim itself.

What is claimed:

1. A method for user collaboration in a business intelligence software tool, the method comprising:
executing a computing server in an operating system of a computing device including a processing unit and system memory, the computing server comprising a business intelligence tool application adapted for rendering data to a group of users for business intelligence;
using a client computer, accessing the business intelligence tool application made available by the computing server, the client computer comprising an input device and an output device;
adding collaborative user notes to a representation of data presented by the business intelligence tool application to the group of users, the step of adding collaborative user notes comprising:
using the client computer, accessing data rendered by the business intelligence tool application and displayed on a data page through the output device;
using the input device of the client computer, entering user collaborative notes in a designated field on the data page;
saving the user collaborative notes on the data page for subsequent retrieval; and
sharing the data page and user collaborative notes with the group of users for collective intelligence.

2. The method according to claim 1, and comprising providing a designated collaboration pane on the data page displayed by the output device for entering contextual collaboration information.

3. The method according to claim 1, and comprising providing an electronic form for entering collaborative user notes on the data rendered by the business intelligence tool application and displayed on the data page through the output device.

4. The method according to claim 1, and comprising providing a selector to identify a specific element of data rendered by the business intelligence tool application and displayed on the data page through the output device.

5. The method according to claim 1, and comprising providing a selector to categorize a collaborative user note displayed on the data page through the output device.

6. The method according to claim 1, and comprising providing a search form to filter collaborative user notes displayed on the data page through the output device.

7. The method according to claim 1, and comprising providing an opinion (like or vote) option for other users in the group to opine on the collaborative user notes displayed on the data page through the output device.

8. The method according to claim 1, and comprising restricting access to the user collaboration notes to authorized users of the group.

9. The method according to claim 1, and comprising bookmarking the data page associated with the user collaborative notes.

10. The method according to claim 1, and comprising assigning a user collaborative note to a selected user of the group.

11. The method according to claim 1, wherein the user collaborative notes comprise one or more of a group consisting of a user comment, annotation, digital images, video, and HTML tag.

12. The method according to claim 1, and comprising selecting a collaboration storage location for writing user collaborative notes pertaining to the data rendered by the business intelligence tool application.

13. The method according to claim 12, wherein the collaboration storage location comprises an enterprise social network.

14. The method according to claim 12, wherein the collaboration storage location comprises a metadata repository database.

15. The method according to claim 12, wherein the collaboration storage location comprises a physical file system selected from a group consisting of a flat file, XML formatted file, and binary file.

16. The method according to claim 1, and comprising providing a collaboration graphical user interface integrated with the business intelligence tool application.

17. A computer-implemented system for user collaboration in a business intelligence software tool, the system comprising:
a computing server executed in an operating system of a computing device including a processing unit and system memory, the computing server comprising a business intelligence tool application adapted for rendering data to a group of users for business intelligence;
a client computer adapted for accessing the business intelligence tool application made available by the computing server, and comprising an input device and an output device; and
the computing device comprising computer-executable instructions stored in the system memory that when executed by the processing logic cause the processing logic to enable a method for adding collaborative user notes to a representation of data presented by the business intelligence tool application to the group of users, the method comprising:
using the client computer, accessing data rendered by the business intelligence tool application and displayed on a page through the output device;
using the input device of the client computer, entering user collaborative notes in a designated field on the data page;
saving the user collaborative notes on the data page for subsequent retrieval; and
sharing the data page and user collaborative notes with the group of users for collective intelligence.

18. A computer program product including program instructions tangibly stored on a computer-readable medium and operable to cause a computing device to perform a method for adding collaborative user notes to a representation of data presented by a business intelligence tool application to a group of users, the method comprising:
executing a computing server in an operating system of a computing device including a processing unit and system memory, the computing server comprising a business intelligence tool application adapted for rendering data to a group of users for business intelligence;
using a client computer, accessing the business intelligence tool application made available by the computing server, the client computer comprising an input device and an output device;
adding collaborative user notes to a representation of data presented by the business intelligence tool application to the group of users, the step of adding collaborative user notes comprising:
using the client computer, accessing data rendered by the business intelligence tool application and displayed on a data page through the output device;
using the input device of the client computer, entering user collaborative notes in a designated field on the data page;
saving the user collaborative notes on the data page for subsequent retrieval; and
sharing the data page and user collaborative notes with the group of users for collective intelligence.

19. The computer program product according to claim 20, wherein the user collaborative notes comprise one or more of a group consisting of a user comment, annotation, digital images, video, and HTML tag.

20. The computer program product according to claim 20, wherein the method further comprises providing a collaboration graphical user interface integrated with the business intelligence tool application.
